(19) United States
(12) Patent Application Publication
(10) Pub. No.: US 2003/0149604 A1
(43) Pub. Date: Aug. 7, 2003

(54) Exception analysis, prediction, and prevention method and system

(76) Inventors: Fabio Casati, Palo Alto, CA (US); Ming-Chien Shan, Saratoga, CA (US); Li-Jie Jin, Mountain View, CA (US); Umeshwar Dayal, Saratoga, CA (US); Daniela Grigori, Berlin (DE)

Correspondence Address: HEWLETT-PACKARD COMPANY, Intellectual Property Administration, P.O. Box 272400, Fort Collins, CO, 80527-2400, US

(21) Appl. No.: 10/057,143

(22) Filed: Jan. 25, 2002

(51) Int. Cl. G06F 17/60

(52) U.S. Cl. 705/7

(57) ABSTRACT

Exception analysis, prediction, and prevention method and system. Exception analysis involves identifying the causes of exceptional behaviors (e.g., deviations from the predetermined standard of execution). Exception prediction involves predicting the occurrence of exceptions as early as possible during the process execution. Exception prevention involves taking actions to avoid exceptions. By performing exception analysis, prediction, and prevention, the occurrence of exceptions is reduced, thereby increasing business process quality.

### FIELD OF THE INVENTION

The present invention relates generally to electronic business technology and business processes, and more particularly, to an exception analysis, prediction, and prevention method and system.

### BACKGROUND OF THE INVENTION

Workflow management is a rapidly evolving technology that many businesses in a variety of industries utilize to handle business processes. A business process, as defined by the Workflow standard—Terminology & glossary, Technical Report WFMC-TC-1011, Workflow Management Coalition, June 1996. Versions 2.0., is simply a set of one or more linked activities that collectively realize a business objective or a policy goal, typically within the context of an organizational structure defining functional roles and relationships. A workflow is defined as the automation of a business process, in whole or in part, during which documents, information, or activities are passed from one participant to another, according to a set of predefined rules. A workflow management system (WfMS) defines, creates, and manages the execution of workflows.

Examples of workflow software include BusinessWare software, available from Vitria Technology, Inc. of Sunnyvale, Calif., Inconcert software, available from TIBCO Software, Inc. of Palo Alto, Calif., MQ Series software, available from International Business Machines Corporation (IBM), of Armonk, N.Y., and Staffware 2000, available from Staffware of Berkshire, United Kingdom.

In order to attract and retain customers, as well as business partners, organizations need to provide their services (i.e., execute their processes) with a high, consistent, and predictable quality. In particular, a critical issue in ensuring business process quality is that of reducing the occurrence of exceptions (i.e., deviations from the optimal or acceptable process execution).

Prior art exists in the field of exception prediction, limited however, to estimating deadline expirations (i.e., predicting that a process will not finish within the desired or allotted time) and based on simple statistical techniques. In the following we summarize these contributions, and then we underline the main differences with the approach proposed in this paper.

One of the first contributions to process time management is described in a publication entitled, “Escalations in Workflow Management Systems” by E. Panagos & M. Rabinovich, Procs. of DART'97, Rockville Md., November 1997. This publication addresses the problem of predicting, as early as possible, when a process instance is not likely to meet its deadline, in order to escalate the problem and take appropriate actions. In the proposed process model, every activity in the process has a maximum duration, assigned by the process designer based on the activity's estimated execution times and on the need to meet the overall process deadline.

When the maximum duration is exceeded, the process is escalated. When an activity executes faster than its maximum duration, a slack time becomes available that can be used to dynamically adjust the maximum durations of the subsequent activity. This activity can take all the available slack or a part of it, proportional to its estimated execution time or to the cost associated to escalating deadline expirations.

Another technique for deadline monitoring and management is described in a publication entitled, “Time Management in Workflow Systems” by J. Eder, E. Panagos, H. Pozewaunig & M. Rabinovich, Procs. of BIS'99, Poznan, Poland, 1999. In the proposed approach, a process definition includes the specification of the expected duration for each activity. This duration can be defined by the designer or determined based on past executions. In addition, the designer may define deadlines for activities or for the whole process. Deadlines specify the latest allowed completion times for activities and processes, defined as interval elapsed since the process instance start time. Processes are translated into a PERT diagram that shows, for each activity, based on the expected activity durations and on the defined deadlines, the earliest point in time when the activity can finish as well as the latest point in time when it must finish to satisfy the deadline constraints. During the execution of a process instance, given the current time instant, the expected duration of an activity, and the calculated latest end time, the progress of the process instance can be assessed with respect to its deadline. This information can be used to alert process administrators about the risk of missing deadlines and to inform users about the urgency of their activities.

These approaches are directed to predicting deadline expiration for workflow instances. First, the average execution time for each node in the workflow is calculated. Then, the completion date and time for a particular instance is calculated by using the current time and adding the average execution times of the nodes that remain to be executed in the workflow.

Unfortunately, these approaches have several disadvantages. First, these approaches fail for processes that are not sequential. For example, in a process with branches, there is no practical way to determine which branch of nodes is to be executed. Since the branches typically have different number of nodes and thus different execution times, the completion date and time cannot be determined by this approach.

Even for sequential processes, these approaches can be inaccurate since the approaches fail to consider the value of workflow data and the resources used in the process. The value of workflow data and the resources used in the process often affect the execution time of the nodes and the processes.

### SUMMARY OF THE INVENTION

In view of the limitations of known systems and methods, it is desirable for there to be a mechanism that extends to other types of exceptions besides deadline expiration, that can handle non-sequential processes, and that considers the value of workflow data and the resources used in the process in predicting exceptions.

Furthermore, there remains a need for a mechanism that, besides exception prediction, also enables exception analysis, to help users in understanding the causes of exception.

According to one embodiment of the present invention, a method and system for exception analysis, prediction, and prevention that increases the quality of business processes are described.

One aspect of the present invention is the provision of a mechanism to reduce the occurrence of exceptions in business processes.

Another aspect of the present invention is the provision of a mechanism to identify the causes of exceptional behaviors.

Another aspect of the present invention is the provision of a mechanism to predict the occurrence of exceptions as early as possible in the process execution.

Another aspect of the present invention is the provision of a mechanism to avoid exceptions.

According to one embodiment, an exception analysis, prediction, and prevention method and system are provided. The system includes an exception analysis unit for performing analysis on exceptions. Exception analysis involves identifying the causes of exceptional behaviors (e.g., deviations from a predetermined standard of execution). The system also includes an exception prediction unit for predicting exceptions. Exception prediction involves predicting the occurrence of exceptions as early as possible during the process execution. The system also includes an exception prevention unit for preventing exceptions. Exception prevention involves taking actions to avoid exceptions. By performing exception analysis, prediction, and prevention, the occurrence of exceptions is reduced, thereby increasing business process quality.

One aspect of the present invention is the provision of an exception processing mechanism, which may be implemented by a suite of tools that supports organizations in analyzing, predicting, and preventing exceptions. Exception analysis helps users in determining the causes of exceptions. For example, the analysis may show that delays in a supply chain process occur whenever a specific supplier is involved. Understanding the causes of exceptions can help information technology and business manager to identify the changes required to avoid future occurrences of the exceptions. For example, the company may decide to remove a given supplier from its approved list, so that no work node is assigned to that supplier.

The exception processing mechanism of the present invention dynamically predicts the occurrence of exceptions at process instantiation time and progressively refines the prediction as process execution proceeds and more information become available. Exception prediction aids to set the right expectations about the process execution quality. Moreover, exception prediction allows users and applications to perform actions in order to prevent the occurrence of exceptions.

For example, when the exception processing mechanism of the present invention predicts that a process instance has a very high probability of missing its deadline, the exception processing mechanism of the present invention can raise the process instance priority to an appropriate priority level. The appropriate priority level can depend on the importance of the process and on the potential damage that may be caused by missing the deadline. The priority level informs resources that work items of this process instance are to be executed first.

Another aspect of the present invention is to apply data mining and data warehousing techniques to process execution logs. Business process automation systems (also called Workflow Management Systems, or simply WfMSs) record all important events that occur during process executions. These recorded events include the start time and completion time of each activity, the input data and output data of each activity, the resource that executed the activity, and any failure that occurs during activity or process execution. By cleaning and aggregating the workflow logs into a warehouse and by analyzing them with data mining technologies, the exception processing mechanism of the present invention extracts knowledge about the circumstances in which an exception occurred in the past. This information is then utilized to explain the causes of the occurrence of the exception, as well as, to predict future occurrences of the exception.

The exception processing mechanism of the present invention is an important component and enabling technology for developing business intelligence techniques and tools for business process reporting, analysis, prediction, and optimization.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates an exception processing unit according to one embodiment of the present invention.

FIG. 2 is a block diagram of an exemplary system for supporting business processes in which the exception processing mechanisms of FIG. 1 may be implemented according to one embodiment of the present invention.

FIG. 3 is a block diagram illustrating in greater detail the exception analysis unit of FIG. 1 in accordance with one embodiment of the present invention.

FIG. 4 is a flow chart illustrating the processing steps performed by the exception analysis unit of FIG. 3 in accordance with one embodiment of the present invention.

FIG. 5 illustrates a block diagram that illustrates the exception prediction unit of FIG. 1 according to one embodiment of the present invention.

FIG. 6 illustrates how more attributes are defined as the process instance executes according to one embodiment of the present invention.

FIG. 7 is a flow chart illustrating the processing steps performed by the exception prediction unit of FIG. 6 in accordance with one embodiment of the present invention.

### DETAILED DESCRIPTION

An exception analysis, prediction, and prevention method and system are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

As used herein, the term exception refers to any behavior, whether negative or positive, that meets a predetermined criteria or standard. Negative behavior can include a deviation from the optimal or acceptable process execution that prevents the delivery of services with the desired or agreed upon quality. Quality refers to either external quality, as perceived from the consumer in terms of better and faster services, internal quality, as perceived by the service provider in terms of lower operating cost, or both.

Positive behavior can include above-average processing times or beneficial outcomes. For example, the method and system of the present invention can be employed to analyze why certain processes execute faster than the average process, or why certain processes have particularly positive outcomes.

It is noted that the term exception may be a high-level, user-oriented notion, where the process designers and administrators may specify and define what is considered an exception. In this regard, an exception can be any problem or any situation of interest, defined by the designers and administrators, that is to be addressed and possibly to be avoided.

Workflow executions may suffer from many types of exceptions. One type of exception may occur when a deadline for the execution of an activity expires. Another type of exception may occur when a deadline for the execution of the entire workflow instance expires. Yet another type of exception may occur when an activity returns an error. Yet another type of exception may occur when a workflow instance is canceled. For example, this type of exception can occur when a customer cancels an order.

Delays in completing an order fulfillment process or escalations of complaints to a manager in a customer care process are other typical examples of exceptions. In the first case a company is not able to meet the service level agreements, while in the second case the service is delivered with acceptable quality from the customer's point of view, but with higher operating costs, and therefore with unacceptable quality from the service provider's perspective.

Exception Processing Mechanism 1100

FIG. 1 illustrates an exception processing mechanism 100 according to one embodiment of the present invention. The exception processing mechanism 100 performs exception analysis, exception prediction, exception prevention, or a combination thereof. The exception processing mechanism 100 includes an exception analysis unit 110 for identifying the causes of exceptional behaviors (e.g., deviations from the acceptable execution).

The exception processing mechanism 100 also includes an exception prediction unit 120 for predicting exceptions. Exception prediction involves predicting the occurrence of exceptions as early as possible during the process execution.

The exception processing mechanism 100 also includes an exception prevention unit 130 for preventing exceptions. Exception prevention involves taking actions to avoid or reduce the impact of exceptions. By performing exception analysis, prediction, and prevention, the exception processing mechanism 100 according to one embodiment of the present invention reduces the occurrence and the impact of exceptions, thereby increasing business process quality.

Preferably, the exception processing mechanism 100 performs all the following functions: exception analysis, exception prediction, exception prevention. However, it is noted that the exception processing mechanism 100 can be configured to perform only one of the functions or any combination of the above-noted functions.

BPI Architecture

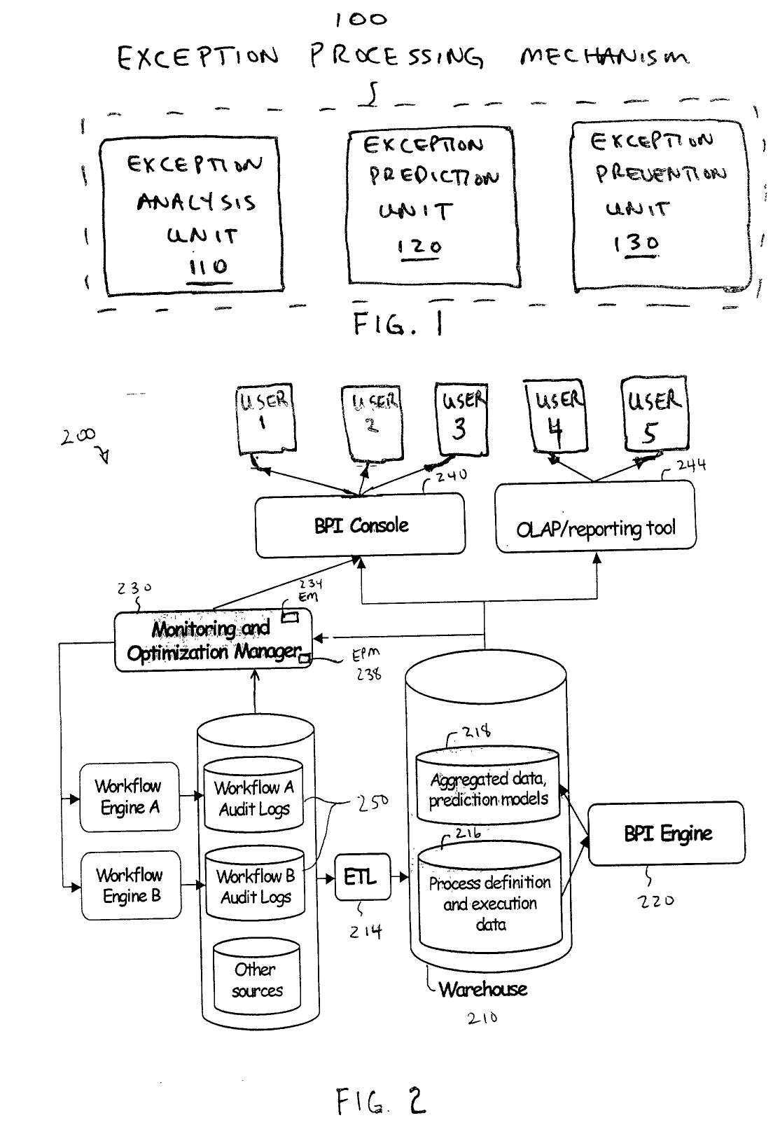

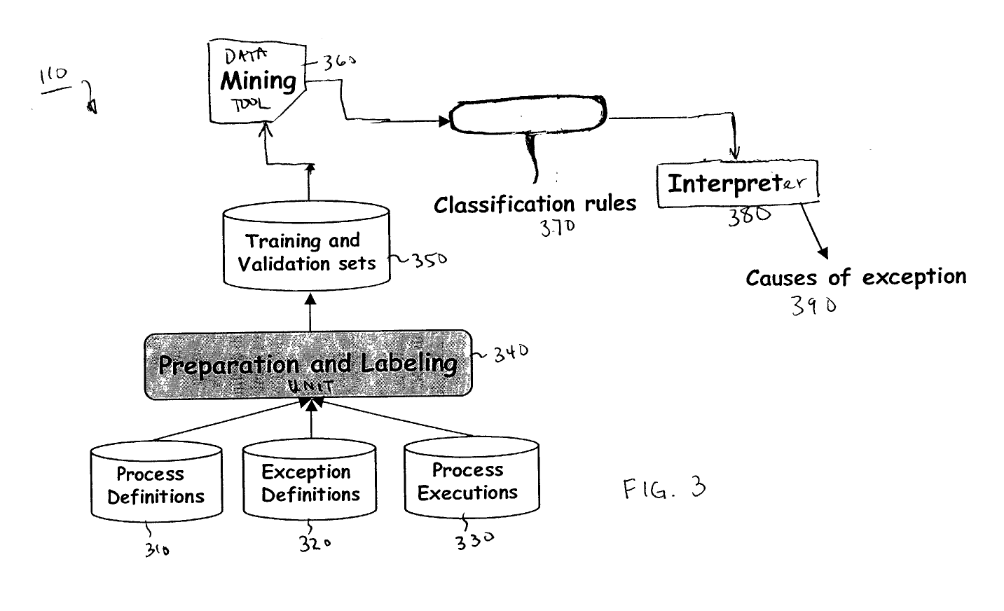

FIG. 2 is a block diagram of an exemplary system 200 for supporting business processes in which the exception processing mechanisms 100 of FIG. 1 may be implemented according to one embodiment of the present invention.

In this embodiment, the exemplary system 200 is configured as a Business Process Intelligence (BPI) tool suite that includes a warehouse 210 of process definition and execution data, a BPI engine 220, and a Monitoring and Optimization Manager (MOM) 230.

There are many commercial workflow management systems (WfMSs), which are available on the market, as well as many research prototypes. While each system has a different process model, most of them share the same basic concepts. In one example, a process is described by a directed graph that has four different kinds of nodes.

Work nodes (also called service nodes) represent the invocation of activities (also called services), which are assigned for execution to a human or automated resource. Route nodes are decision points that route the execution flow among nodes based on an associated routing rule. Start nodes denote the entry point to the process. Typically, only one start node is allowed in a process. Complete nodes denote termination points.

Arcs in the graph denote execution dependencies among nodes: when a work node execution is completed, the output arc is “fired”, and the node connected to this arc is activated. Arcs in output to route nodes are instead fired based on the evaluation of the routing rules.

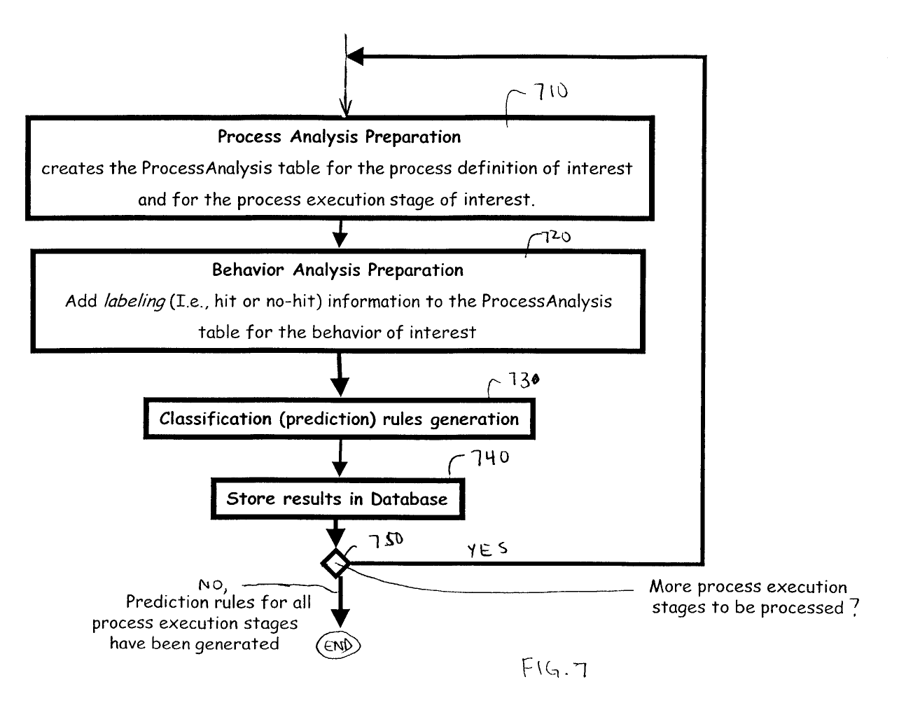

Referring to FIG. 6, an exemplary process entitled, “Expense Approval process,” is provided. This is a simplified version of an actual process that is employed to request approval for various kinds of expenses. The process is started by the requester, who also specifies the expense amount, the reasons, and the names of the clerks and managers that should evaluate the request. Next, an email is sent to the requester to confirm the start of the process. The process then loops among the list of selected clerks and managers, until either all of them approve the expense or one of them rejects it. Finally, the result is notified to the requester.

Every work node is associated to a service description that defines the logic for selecting a resource (or resource group) to be invoked for executing the work. The service also defines the process data items to be passed to the resource upon invocation and received from the resource upon completion of the work. It is noted that several work nodes can be associated to the same service description.

When a work node is scheduled for execution, the WfMS reads the corresponding service description, executes the resource selection rule associated to the service description, and puts the work item to be performed into the resource's worklist. Resources periodically connect to WfMS, pick a work item assigned to them (or to a group to which they are a member), and then execute the work item.

WfMSs log information on process executions into an audit log database, typically stored in a relational DBMS. The audit log database include information on process instances (e.g., activation and completion timestamps, current execution state, name of the user that started the process instance), service instances (e.g., activation and completion timestamps, current execution state, name of the resource that executed the service, name of the node in the context of which the service was executed), and data modifications (e.g., the new value for each data item every time it is modified.) Data is periodically extracted from WfMS logs 250 and loaded into the warehouse 210 by Extract, Transfer, and Load (ETL) scripts 214. The warehouse 210 is designed to support a wide range of reporting functionalities (e.g., high-performance multidimensional analysis of process execution data that may be provided from heterogeneous sources). The warehouse 210 can include, for example, process definition and execution data 216 and aggregated data and prediction models 218 that are generated by the BPI engine 220. Further details of a BPI warehouse 210 that is suitable for system 200 is described in a publication entitled, “Warehousing Workflow Data: Challenges and Opportunities,” by A. Bonifati, F. Casati, U. Dayal, and M. C. Shan, Procs. of VLDB'01, Rome, Italy. September 2001.

According to one embodiment of the present invention, the BPI engine 220 is configured to execute data mining algorithms on the data in the warehouse 210 in order to: 1) understand the causes of specific behaviors, such as the execution of certain paths in a process instance, the use of a resource, or the ability or inability to meet service level agreements; and 2) generate prediction models (e.g., information that can be used to predict the behavior and performances of a process instance, of the resources, and of the WfMS).

The BPI engine 220 stores the extracted information in the warehouse 210, so that the information can be easily and efficiently accessed through a BPI console 240 or through external OLAP and reporting tools 244.

The Monitoring and Optimization Manager (MOM) 230 accesses information in the warehouse 210 and information about running process instances stored in the WFMS logs (referred to herein as “live” information) to make predictions and dynamically optimize process instance executions. For example, MOM 230 can be configured to raise the priority of a process instance when there is a high probability that the instance will not finish on time. MOM 230 can also alert process administrators about foreseen critical situations.

Exception Analysis Unit 110

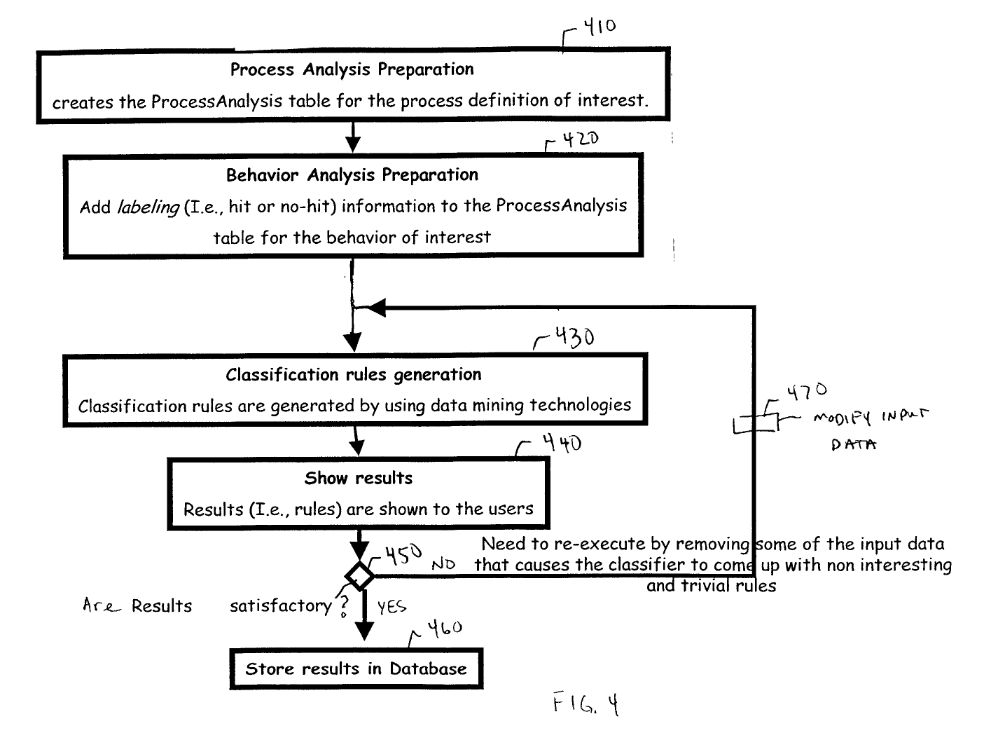

FIG. 3 is a block diagram illustrating in greater detail the exception analysis unit 110 of FIG. 1 in accordance with one embodiment of the present invention. The exception analysis unit 110 performs analysis on exceptions and aids business users in understanding the causes of exceptions.

According to one embodiment of the present invention, the approach to analyze why instances of a certain process are affected by a specific exception includes four phases. A process data preparation phase selects the process instance attributes to be included as part of the input data set to be analyzed. Relevant attributes can include, for example, the values of process data items at the different stages during process instance execution, the name of the resources that executed activities in the process instance, the duration of each activity, or the number of times a node was executed. Once the attributes of interest have been identified, then a data structure (e.g., a relational table) is created and populated with process instance execution data.

Alternatively, the process data preparation phase can select different attributes based on the kind of exception being analyzed (i.e., a process-specific and exception-dependent data preparation phase).

An exception analysis preparation phase joins in a single view the information generated by the previous phase with the exception labeling information (e.g., information that indicates whether the instance is exceptional or not exceptional), computed by the BPI engine 220 at exception definition time.

A mining phase applies classification algorithms to the data generated by the data preparation phase.

Finally, in the interpretation phase, the analyst interprets the classification rules to understand the causes of the exception, and in particular to identify problems and inefficiencies that can be addressed and removed.

A few iterations of the mining and interpretation phases may be needed in order to identify the most interesting and effective classification rules. In particular, the mining phase may generate classification rules that classify process instances based on attributes that are not interesting in the specific case being considered. For example, when an obvious and not interesting correlation is generated, an analyst may want to repeat the mining phase and selectively remove one or more attributes from the ones considered in generating the classification rules, so that the classifier can focus on more meaningful attributes.

The exception analysis unit 110 includes process definitions 310, exception definitions 320, and process executions 330. The exception analysis unit 110 also includes a preparation and labeling unit 340 for generating training and validation sets 350 based on the process definitions 310, exception definitions 320 and process executions 330. In one embodiment, the process definitions 310, exception definitions 320, process executions 330, and training and validation data sets 350 are stored in the warehouse 210.

The exception analysis unit 110 also includes a data mining (DM) tool 360 for generating classification rules 370 (also referred to herein as results) based on the training and validation sets 350. The classification rules 370 are then provided to an interpreter 380 (e.g., a user) that determines the causes 390 of exceptions.

According to one embodiment of the present invention, the exception analysis unit 110 applies data mining techniques on top of process definition and execution data to perform exception analysis. Preferably, the exception analysis unit 110 treats exception analysis as a classification problem where there are objects and classes. In this embodiment, the process instances are the objects, and there are two classes: 1) an exceptional class, and 2) a normal class. In this case, the exception analysis unit 110 derives classification rules in order to put objects in the proper classes. The data mining support mechanism 360 may be utilized to define objects and classes and to derive classification rules in terms of objects' attributes.

The DM tool 360 may be trained by identifying some exceptional instances. Once trained by the training examples, the DM tool 360 can automatically generate classification rules. The resulting classification rules 370 identify the causes of the exceptions in terms of process instance attributes.

Behavior Analysis Processing

FIG. 4 is a flow chart illustrating the processing steps performed by the exception analysis unit 110 of FIG. 3 in accordance with one embodiment of the present invention. In step 410, a table (e.g., a Process Analysis table) for the process definition of interest is created in a process analysis preparation phase. In one embodiment, step 410 can be executed once per process independent of which behavior is being analyzed. Alternatively, this step can be tailored to a specific behavior. In this manner, the analysis is usually more effective, but there is the expense of increased processing time and storage space.

In step 420, labeling information is added to the table for the behavior of interest in the behavior analysis preparation phase. The labeling information defines which process instances has which behavior. For example, the labeling information can be a “hit” or “no hit.”

In step 430, classification rules are generated by using data mining techniques in the classification rules generation phase. In step 440, the results (i.e., rules) are displayed for viewing by the user.

In decision block 450, a determination is made by the user whether the results (i.e., rules) are satisfactory. When the results are satisfactory, in step 460 the results are stored, for example, in a database. When the results are not satisfactory, in step 470 the input data is modified, and processing proceeds to processing step 430. Steps 430 to 450 are then repeated or re-executed based on the modified input data. For example, some of the input data that causes the classifier to generate non-interesting rules or trivial rules may be removed.

As a more specific example, the classification rules will identify a correlation between the process instance duration and a deadline expiration exception. However, this is an obvious and not very interesting correlation. Consequently, an analyst may repeat the mining phase and remove the process instance duration attribute from the attributes considered in generating the classification rules. In this manner, the classifier can focus on more interesting attributes.

Alternatively, the process data preparation phase can select different attributes based on the kind of exception being analyzed (i.e., a data preparation phase that is process-specific and exception-dependent).

Classification applications typically require input data to reside in a relational table, where each tuple describes a specific object. In this regard, one embodiment of the behavior analysis method of the present invention includes a step (step 410) for preparing a process-specific table (referred to herein also as a process analysis table). The process analysis table includes one row per process instance, where the columns correspond to process instance attributes. One additional column is needed in the process analysis table to store labeling information. This preparation step (step 410) enables an analysis of why an exception affects instances of a process.

However, the information about a single object (process instance) in the BPI warehouse is scattered across multiple tables, and each table may contain multiple rows related to the same process instance. Hence, there is the problem of defining a suitable process analysis table and of populating it by collecting process instance data.

In addition, even within the same process, different instances may have different attributes. The problem here is that a node can be activated a different number of times in different instances. The number of such activations is a-priori unknown. Hence, not only is there a need for identifying the interesting node execution attributes to be included in the process analysis table, but also how many node executions (and which ones) should be represented.

This issue can be addressed in several ways. In one embodiment, only a specific node execution (e.g., the first one or the last one) can be considered for the analysis. An alternative approach consists in considering all executions of every node in each process instance. In this case, the process analysis table must have, for each node, a number of columns proportional to the maximum number of executions of that node, which can be determined by evaluating the process instance data in the warehouse.

However, despite the fact that this technique provides more information to the mining phase, it does not necessarily give better results. In fact, tables generated in this manner typically include many undefined (NULL) values, especially if the number of node activations greatly differs from instance to instance. Data mining tools do not manage sparse tables well. Moreover, when classifications are based on a large number of similar attributes that often have null values, it is very difficult to interpret and understand the results. Finally, this approach can computationally intensive.

Preferably, two attribute (column) sets are inserted for each node that can be executed multiple times: one attribute set represents the first execution, and the second attribute set represents the last execution of that node. Experiments that were conducted on different processes indicate that the first and last executions of a node in the process have a higher correlation with many kinds of process exceptions, such as those related to process execution time and to the execution of a given subgraph in the process.

It is noted that the number of process instance attributes of interest is in general unlimited. For example, an exception could be related to the ratio between the durations of two nodes in the process or to the sum of two numeric data items.

In one embodiment, the process analysis table includes the following attributes for each process instance:

1) Activation and completion timestamps. These timestamps correspond to multiple columns that decompose the timestamps in hour of the day, day of the week, etc., and with the addition of a holiday flag to denote whether the process was instantiated on a holiday.

2) Data items: Initial values of the process data items plus the length (in bytes) of each item.

3) Initiator: Resource that started the process instance.

4) Process instance duration.

In one embodiment, the process analysis table includes attributes for each node in the process:

1) Activation and completion timestamps that may be decomposed as described for the process instance timestamps.

2) Data items: Values of the node output data plus the length (in bytes) of each item.

3) Resource that executed the node.

4) Final state of the node (e.g., completed or failed)

5) Node duration.

6) Number of activations of the node in the process instance. Preferably, this attribute is only included once per node, even if two attribute sets are used for this node since the value would be the same for both.

It is noted that two sets of attributes are included for nodes that can be executed multiple times.

Selected Attributes

TABLE I
illustrates exemplary attributes of a process analysis table for analyzing
an expense approval process.

| ATTRIBUTES | SAMPLE VALUE |
|---|---|
| +UZ, 1/12 Process-specific attributes | |
| Process start year | 2001 |
| Process start quarter | 1 |
| Process start month | Feb |
| Process start day | 23 |
| Process start day of week | Fri |
| Process start hour | 17 |
| Process start Min | 22 |
| Process started on Holiday? | N |
| Process end year | 2001 |
| Process end quarter | 1 |
| Process end month | Feb |
| Process end day | 26 |
| Process end day of week | Mon |
| Process end hour | 18 |
| Process end Min | 30 |
| Process ended on Holiday? | N |
| Process Instance Initiator | John |
| Process Instance Duration | 3 days 1 hour |
| | 8 minutes |
| Initial value of process variable | John |
| REQUESTOR | |
| Initial value of process variable AMOUNT | 500$ |
| Initial value of process variable | — |
| APPROVED | |
| Initial value of process variable | NO |
| NOTIFIED | |
| Repeat For all other process | |
| variables . . . | |
| Node “notify requester of initiation” start year | 2001 |
| Node “notify requester of initiation” start | 1 |
| quarter | |
| Node “notify requester of initiation” start | Feb |
| month | |
| Node “notify requester of initiation” start day | 23 |
| Node “notify requester of initiation” start day | Fri |
| of week | |
| Node “notify requester of initiation” start hour | 17 |
| Node “notify requester of initiation” start min | 24 |
| Node “notify requester of initiation” started on | N |
| Holiday? | |
| Node “notify requester of initiation” end year | 2001 |
| Node “notify requester of initiation” end | 1 |
| quarter | |
| Node “notify requester of initiation” end | Feb |
| month | |
| Node “notify requester of initiation” end day | 23 |
| Node “notify requester of initiation” end day | Fri |
| of week | |
| Node “notify requester of initiation” start hour | 17 |
| Node “notify requester of initiation” start min | 25 |
| Node “notify requester of initiation” ended on | N |
| Holiday? | |
| Number of activations of node “notify | 1 |
| requester of initiation” | |
| Duration of node “notify requester of | 1 minute |
| initiation” | |
| Executor of node “notify requester of | Email_server |
| initiation” | |
| Final state of node “notify requester of | COMPLETED |
| initiation” | |
| value of process variable NOTIFIED after | YES |
| execution of node “notify requester of | |
| initiation” (which is the only variable | |
| modified by this node) | |
| . . . | |
| . . . | |
| . . . | |
| Repeat with analogous information for each | |
| node. For work nodes that can be executed | |
| multiple times (e.g., a node within a loop), the | |
| information placed in the table is actually | |
| double with respect to that for the “notify | |
| requester of initiation” node, since data | |
| corresponding to the first and the last | |
| execution of that node are place into the | |
| table. | |

The process analysis table is automatically built by a process analysis preparation script. This script takes the name of the process to be analyzed as input parameter, and retrieves process definition information from the BPI warehouse. In particular, the script identifies the nodes and data items that are part of the process, and creates the process analysis table. Then, the script populates the table with process instance data. Users can also restrict the process analysis table to contain only data about instances started within a time interval.

The exception analysis preparation phase is implemented by process-independent and exception-independent PL/SQL code that receives as parameter the name of the process and of the exception to be analyzed, and generates a process- and exception-specific view. The view joins the Process Analysis and Process Behaviors tables to provide a data set that includes process instance attributes as well as labeling information.

The process behaviors table is a process-independent and exception-independent table that lists which instances have been affected by which exceptional behaviors. TABLE II is an exemplary process behavior table that defines which process instances had a certain behavior. The first column lists process instance identifiers and the second column lists behavior identifiers.

TABLE II

| Process Instance | |
|---|---|
| Identifier | Behavior Identifier |
| P23 | B13 |
| P41 | B13 |
| P95 | B21 |
| P23 | B60 |
| . . . | . . . |

The obtained view includes all the information required by the classification tool to generate the classification rules.

TABLE III is an exemplary table that merges the process analysis table and the process behavior table. The columns entitled, “First Attribute”, “Second Attribute”, . . . , “Nth Attribute,” mirror the titles of the attributes in the process analysis table. The column entitled “HadBehavior” defines whether a process instance has a behavior to be analyzed. This column is hereinafter also referred to as a label column.

TABLE III

| | | | | | | |
|---|---|---|---|---|---|---|
| Process | | | | | | |
| instance | First | Second | Third | | Nth | |
| identifier | Attribute | Attribute | Attribute | . . | Attribute | HadBehavior? |

| | |
|---|---|
| P23 | Yes |
| P41 | No |
| P95 | No |
| . . . | . . . |

The mining phase can be performed by using different algorithms and techniques. In one embodiment, decision trees are utilized for exception analysis. Decision trees are employed in this case because they work well with very large data sets, with large number of variables, and with mixed-type data (e.g., continuous and discrete). In addition, decision trees are relatively easy to understand even by non-expert users, and therefore simplify the interpretation phase. With decision trees, objects are classified by traversing the tree, starting from the root and evaluating branch conditions (decisions) based on the value of the objects' attributes, until a leaf node is reached. All decisions represent partitions of the attribute/value space, so that one and only one leaf node is reached. Each leaf in a decision tree identifies a class. Therefore, a path from the root to a leaf identifies a set of conditions and a corresponding class (i.e., the path identifies a classification rule). Leaf nodes also contain an indication of the rule's accuracy (i.e., the probability that objects with the identified characteristics actually belong to that class). Decision tree building algorithms in particular aim at identifying leaf nodes in such a way that the associated classification rules are as accurate as possible.

Once a decision tree has been generated by the mining tool, analysts can focus on the leaf nodes that classify instances as exceptional. Then, they can traverse the tree from the root to the leaf, to identify which attributes and attribute values lead to the leaf node, and therefore identify the characteristics of “exceptional” instances.

As can be appreciated, understanding the causes of an exception is an important step to eliminating those causes, thereby improving the quality of process execution.

Exception Prediction Processing

The problem of exception prediction has many similarities with that of exception analysis. In fact, exceptions could be predicted by identifying the characteristics of exceptional instances, and by then checking whether a running process instance has those characteristics.

Unfortunately, classification rules that are generated by exception analysis perform very poorly and may not even be applicable for predictions about running instances. In fact, it is desirable to classify process instances as “normal” or “exceptional” while they are in progress, and possibly in their very early stages. Consequently, the value of some attributes, such as, the executing resource or the duration for a node yet to be executed, may be undefined. If the classification rules generated by the exception analysis phase include such attributes, then the rules cannot be applied, and the process instance cannot be classified.

For example, assume that decision tree-building algorithms have been used in the mining phase. If undefined attributes appear in the branch conditions of the decision tree, then the branch condition cannot be evaluated. The prediction becomes less accurate as the undefined attributes appear in branch conditions closer to the root of the tree since we can only follow the tree and improve the classification accuracy while branch conditions can be evaluated. At an extreme, if undefined attributes are in the branch condition at the root of the tree, then the decision tree does not give any useful information.

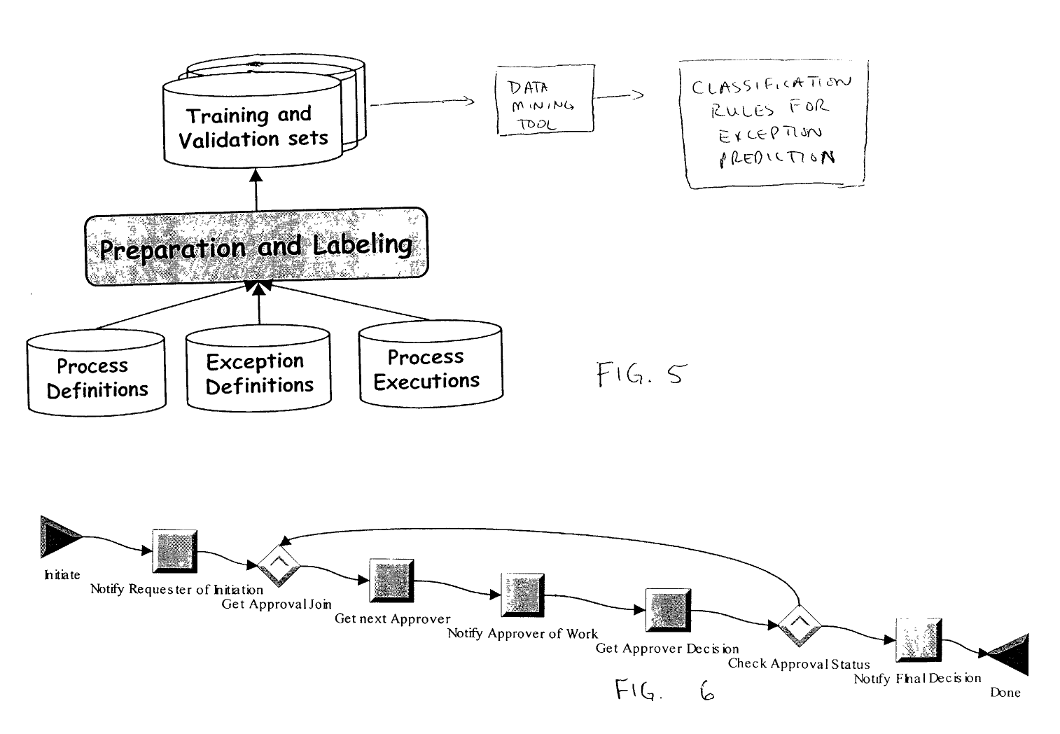

FIG. 5 illustrates a block diagram that illustrates the exception prediction approach according to one embodiment of the present invention. The components are similar to those of FIG. 3 and for the sake of brevity the descriptions of the components are not repeated herein. An important difference between FIG. 3 and FIG. 5 is that multiple training and validation sets are employed for exception prediction. Specifically, several training sets or validation sets are prepared, where there is preferably one set for each execution stage. Each set is tailored to generate classification rules for a specific stage of the process instance execution. A stage is characterized by the set of nodes executed at least once in the instance.

For example, a process analysis table, which is targeted at deriving classification rules applicable at process instantiation time, is prepared by assuming knowledge of only the process instance input data, the starting date, and the name of the resource that started the instance. In this manner, only these attributes appear in the classification rules. Such rules can then be used for making predictions with the information known at that execution stage.

For each stage, a process analysis table is constructed as described previously for exception analysis. At the first stage, no node has been executed. The first stage is used to make predictions at process instantiation time. For this stage, the process analysis table can include information about the instantiation timestamp, the initial value of process data items, and the resource that started the instance.

The process analysis tables, generated for the other stages, can include, for each executed node, the same node attributes described previously in connection with exception analysis.

FIG. 7 is a flow chart illustrating the processing steps performed by the exception prediction unit 120 of FIG. 1 in accordance with one embodiment of the present invention. In step 710, a table (e.g., a Process Analysis table) for the process stage being considered is created in a process analysis preparation phase. This phase may be implemented through a script that takes the process name as an input parameter and generates the process analysis table for that process and stage.

FIG. 6 illustrates how more attributes are defined as the process instance executes and goes through the different execution stages. For example, at the Initiate Node, the requester and the process input data are defined. At the NotifyRquesterofInitiation node, the requester, process input data, duration of the first node, and the output data of the first node are defined. It is noted that more attributes become defined as the process instance executes and goes through the different execution stages.

In step 720, labeling information is added to the table for the behavior of interest in the behavior analysis preparation phase. The labeling information can be, for example, “hit” or “no-hit”.

In step 730, classification rules are generated by using data mining techniques in the classification rules generation phase. In step 740, the results (e.g., the classification rules) are stored, for example, in a database.

In decision block 750, a determination is made whether classification rules have been generated for all process execution stages. When classification rules have been generated for all process execution stages processing ends. When prediction rules have not been generated for all process execution stages (i.e., there are more execution stages to be processed), processing proceeds to processing step 710. Steps 710 to 750 are then repeated for the next execution stage. In this manner, classification rules are generated for each execution stage in the process.

Referring again to FIG. 2, the MOM 230 includes an exception monitor (EM) 234 for executing the prediction phase. The EM 234 accesses both the warehouse 210 and the WfMS logs 250 (e.g., workflow_A audit logs and workflow_B audit logs) in order to make predictions. The EM 234 accesses the warehouse 210 to retrieve the classification rules that are generated previously. It is noted that the WfMS logs 250 include “live” data, whereas the warehouse 210 may not. For example, the warehouse 210 may be updated only periodically (e.g., once a day or once a month), depending on the business needs.

Consequently, while classification rules can be obtained “off-line” by analyzing warehouse data, actual predictions need to be made on the live data that the WfMS writes in its logs. Preferably, the mining phase stores its output in the database, so that rules can be interpreted by humans and also be used by applications, such as the EM 234.

In one embodiment, the EM 234 operates by periodically accessing the WfMS audit logs 250 and copying the tables containing information about process instance executions. This operation is executed on top of a relatively small database and has a negligible effect on the performance of the operational system since data is periodically purged from the audit log and archived in the warehouse 210. Once the data has been copied, the EM 234 examines instances of processes to be monitored.

Specifically, for each instance the EM 234 first determines the execution stage by checking which nodes have been executed. Next, the EM 234 accesses the warehouse 210 to retrieve the classification rules to be applied that may, for example, be in the form of a decision tree) based on the execution stage.

Once the appropriate decision tree has been identified, the EM 234 scans the tree and evaluates each branch condition based on the value of the process instance attributes, until a leaf node is reached. The leaf node contains an indication of the probability that the examined instance is exceptional. If this probability is above a predetermined threshold, then a new tuple is inserted into a warning table, detailing the process instance identifier, the exception identifier, the execution stage, and the probability of the exception occurrence.

It is noted that the exception prediction unit 120 generates predictions on “live” process execution data. At run-time, process instances are monitored by the monitoring and optimization manager (MOM) 230. When exceptions are predicted with a predetermined probability (e.g., a high probability), alerts can be issued. For example, when Instance #28 has a 2% probability of generating an exception or when Instance #36 has a 6% probability of generating an exception, and the predetermined probability is 55%, no alert is generated. However, when Instance #53 has a 71% probability of generating an exception, and the predetermined probability is 55%, an alert is generated.

Exception Prevention Unit 130

The exception prevention unit 130 performs exception prevention, which involves taking actions to avoid exceptions or to otherwise mitigate the consequences of the exceptions. For example, when the exception prediction unit 120 of the present invention determines that a workflow has a high probability of not meeting a particular deadline, the exception prevention unit 130 can assign more resources to the workflow. Alternatively, the exception prevention unit 130 can increase or raise the priority of the workflow so that both the users involved and the system can process the nodes of the workflow in a quicker manner.

In addition, the exception prevention unit 130 can notify other parties that are involved in the workflow about the possible occurrence of an exception. For example, the exception prevention unit 130 can warn a customer that a product may not be shipped at the originally promised ship date or that the product may be shipped later than expected.

Preferably, the exception prevention unit 130 includes an automatic notification module that may be configured by a workflow designer to automatically generate a message to a customer when the probability of an exception occurring (e.g., missing a promised delivery date) exceeds a predetermined level (e.g., greater than 90% probability of not meeting a delivery date).

Other actions that may be performed by the exception prevention unit 130 to avoid exceptions or to otherwise mitigate the consequences of the exceptions include, but are not limited to, changing the resource assignment criteria, changing priorities in a work queue, changing path selection criteria, and alerting system administrators to add more resources. For example, when there is a high probability that a particular process will not execute in a timely fashion, and the process is very important, changes in the workflow can be made. These changes can include instructing the workflow engine to employ a faster path with more resources for the process or increasing the priority of the process. As can be appreciated, the actions to prevent exceptions are specific to the particular exception.

According to one embodiment of the present invention, the exception prevention unit 130 predicts the occurrence of exceptions as early as possible in process executions, so that they can be prevented, or so that at least adequate expectations about the process execution speed and quality can be set.

In this regard, the process data preparation phase is modified so that it generates several different process analysis tables that eventually results in several different classification rule sets. Each table is tailored to make predictions at a specific stage of the process instance execution. A stage is characterized by the set of nodes executed at least once in the instance. For example, a process analysis table, which is targeted at deriving classification rules applicable at process instantiation time, is prepared by assuming knowledge of only the process instance input data, the starting date, and the name of the resource that started the instance. In this manner, only these attributes appear in the classification rules.

The other phases are executed in a manner that is similar to that as described previously in connection with exception analysis, with the difference that the phases are performed once for every table generated by the process data preparation phase. In addition to the phases common with exception analysis, exception prediction also includes a prediction and a reaction phase.

The prediction phase is where predictions on running process instances are actually made. In this phase, classification rules are applied to live instance execution data, to classify the instances and obtain, for each running instance and each exception of interest, the probability that the instance will be affected by the exception.

In the reaction phase, users or systems are alerted about the risk of the exception and take the appropriate actions to reduce the “damage” caused by the exception or possibly to prevent its occurrence.

The process data preparation, prediction, and reaction phases are now described in greater detail. For the sake of brevity, the other phases are not repeated since these phases are performed and implemented in a similar fashion as described previously.

The process data preparation phase first determines the possible process instance stages (i.e., the different possible combinations of node execution states (executed or not executed)). Then, for each stage, a process analysis table is constructed as described previously. At the first stage, no node has been executed. The first stage is used to make predictions at process instantiation time. For this stage, the process analysis table can include information about the instantiation timestamp, the initial value of process data items, and the resource that started the instance.

Referring again to FIG. 2, the MOM 230 also includes an exception prevention manager (EPM) 238 for executing a reaction phase. The EPM 238 monitors the warning table. When a new exception is predicted for a process instance, the EPM 238 alerts the user registered as the contact person for the process. Users can then perform actions on the WfMS or in the organization to try to prevent the exception or to reduce its impact.

Moreover, the EPM 238 can be configured to proactively interact with the WfMS in an attempt to prevent the exception. Automated intervention can include raising the process instance priority for those instances that are likely to be late. For example, the process administrator can specify the level to which the priority can be raised depending on the probability of the process instance being late. The EPM 238 can be configures with automatic reaction capabilities. These capabilities can include, but are not limited to, modifying process instance and work node priorities based on the risk and cost of missing service level agreements (SLAs); modifying resource assignment policies so that activities are given to faster resources; and influencing decision points in the process, so that the flow is routed on certain subgraphs when the routing avoids the exception while still satisfying the customers and process goals. Prevention can also involve changing resource assignment criteria, changing priorities in the work queue, changing path selection criteria, and alerting administrators to add more resources.

By performing exception analysis, prediction, and prevention, the exception processing mechanism of the present invention can reduce the occurrence of exceptions, thereby increasing business process quality.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A system for processing exceptions comprising:
a) an exception analysis unit for identifying the causes of exceptional behaviors;
b) an exception prediction unit for predicting the occurrence of exceptions; and
c) an exception prevention unit for one of preventing exceptions and reducing the impact of an exception.

2. The system of claim 1 further comprising:
c) an exception prevention unit for one of preventing exceptions and reducing the impact of an exception.

3. The system of claim 1 wherein the exception includes one of a positive behavior and a negative behavior.

4. The system of claim 1 wherein the exception includes deviations from a predetermined standard of execution.

5. The system of claim 1 wherein the exception prediction unit predicts the occurrence of exceptions as early as possible during the process execution.

6. The system of claim 1 further comprising:
an exception monitor for building a warning table; and
an exception prevention manager for monitoring the warning table and based thereon for performing at least one of preventing the exception and reducing the impact of the exception.

7. The system of claim 6 wherein the exception prevention manager performs one of raising process instance priority to a predetermined priority level for instances that are likely to be late, modifying process instance and work node priorities, modifying resource assignment policies, and influencing decision points.

8. The system of claim 6 wherein the warning table includes a process instance identifier, an exception identifier, an execution stage, and probability of an exception occurrence.

9. A method for analyzing exceptions in a workflow instance comprising the steps of:
a) preparing data from past workflow executions;
b) generating at least one exception analysis model based on the prepared data; and
c) using the exception analysis model to provide information on the causes of the exception.

10. The method of claim 9 wherein the step of generating at least one exception analysis model based on the prepared data includes the steps of
building a process analysis table for a process definition of interest;
adding labeling information to the process analysis table; and
generating classification rules by employing data mining techniques.

11. The method of claim 10 further comprising the steps of:
displaying the classification rules to a user;
selectively removing input data to refine classification rules; and
re-generating classification rules by employing data mining techniques.

12. The method of claim 11 further comprising the steps of:
when the classification rules are satisfactory to the user, storing the classification rules in a database.

13. The method of claim 10 wherein the step of building a process analysis table for a process definition of interest is one of executed once per process independently of which behavior is being analyzed and tailored to a specific behavior.

14. The method of claim 10 wherein classification rules are shown and stored as decision trees.

15. A method for predicting exceptions in a workflow instance comprising the steps of:
a) preparing data from past workflow executions;
b) generating at least one exception prediction model based on the prepared data; and
c) using the exception prediction model to generate at least one prediction of an exception for a current instance of the workflow.

16. The method of claim 15 wherein exception prediction includes the steps of
building a process analysis table for a process definition of interest;
adding labeling information to the process analysis table; and
generating classification rules by employing data mining techniques.

17. The method of claim 15 wherein the classification rules generated for each stage in a process are stored in a repository.

18. The method of claim 17 wherein at least one classification rule set generated for a process execution stage is executed to make predictions on at least one running process instance.

19. The method of claim 18 wherein at least one prediction is stored in a repository; wherein the prediction stored in a repository includes the exception being predicted and an indication of the accuracy of the prediction.

20. The method of claim 15 wherein the predictions are reported to the WfMS so that it can alter the execution of processes to try to avoid the exception;

21. The method of claim 15 further comprising:
reporting classification rules to a user.
selectively removing input data to refine classification rules; and
re-generating classification rules by employing data mining techniques.

22. The method of claim 15 wherein when the classification rules are satisfactory to the user, storing the classification rules in a database.
